(19) United States
(12) Patent Application Publication
(10) Pub. No.: US 2026/0349548 A1
(43) Pub. Date: Nov. 5, 2026

(54) Display Device

(71) Applicant: AUO Corporation, Hsinchu City (TW)

(72) Inventor: Tsung-Ying KE, Hsinchu City (TW)

(21) Appl. No.: 19/413,779

(22) Filed: Dec. 9, 2025

(30) Foreign Application Priority Data
Apr. 30, 2025 (TW) 114116360

(51) Int. Cl. G06F 3/041; G06F 3/04886

(52) U.S. Cl. CPC G06F 3/041; G06F 3/04886; G06F 2203/04102

(57) ABSTRACT

A display device includes a lifting mechanism, a flexible display panel and a bonding layer. The lifting mechanism includes a fixed portion and a movable portion. The fixed portion is located outside the movable portion. The flexible display panel is disposed on the lifting mechanism and has a first region and a second region. The second region is located outside the first region. The movable portion is suitable to lift relative to the fixed portion to drive the first region upward to protrude relative to the second region. The bonding layer is disposed between the lifting mechanism and the flexible display panel, and includes a first adhesive portion and a non-adhesive region. The first adhesive portion at least corresponds to the fixed portion. The non-adhesive region corresponds to at least a portion of the movable portion and to a portion of the fixed portion close to the movable portion.

### CROSS-REFERENCE TO RELATED PATENT APPLICATION

This non-provisional application claims priority to and the benefit of, pursuant to 35 U.S.C. § 119(a), patent application Serial No. 114116360 filed in Taiwan on Apr. 30, 2025. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present disclosure relates to relates to a display device, and particularly to a display device including a flexible display panel.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

With the development of the information society, demands for electronic devices that display images in various forms have been increasing, and examples of the electronic devices include smartphones, laptop computers, navigation systems, smart televisions, etc. Generally, a touch screen may serve as an input unit of an electronic device, allowing a user to input commands by touching the screen with a hand of the user or an object, and implementing a virtual keyboard that is touchable on the screen.

However, since the virtual keyboard does not have physical protrusions, it is difficult for the user to type as quickly and accurately as on a physical keyboard without tactile feedback.

### SUMMARY

The present disclosure provides a display device, which may be switched between planar and curved states by a flexible display panel, and may prevent strain concentration in specific regions during the switching process that would otherwise cause excessive strain.

In certain aspects of the present disclosure, the display device includes a lifting mechanism, a flexible display panel and a bonding layer. The lifting mechanism includes a fixed portion and a movable portion, and the fixed portion is located outside the movable portion. The flexible display panel is disposed on the lifting mechanism and has a first region and a second region, and the second region is located outside the first region. The movable portion is configured to lift relative to the fixed portion to drive the first region upward so as to protrude relative to the second region. The bonding layer is disposed between the lifting mechanism and the flexible display panel, and includes a first adhesive portion and a non-adhesive region. The first adhesive portion at least corresponds to the fixed portion, and the non-adhesive region corresponds to at least a portion of the movable portion and to a portion of the fixed portion close to the movable portion.

In one embodiment of the present disclosure, the fixed portion includes a receiving space, and the movable portion is movably disposed in the receiving space along a first direction.

In one embodiment of the present disclosure, the lifting mechanism further includes a driving portion connected to the movable portion.

In one embodiment of the present disclosure, in the first direction, the non-adhesive region at least overlaps with a junction between the movable portion and the fixed portion.

In one embodiment of the present disclosure, the fixed portion includes a first side and a second side adjacent to each other, the first side faces the flexible display panel, the second side faces the receiving space, the non-adhesive region has an outer end close to the first adhesive portion, and the outer end overlaps with the fixed portion in the first direction.

In one embodiment of the present disclosure, in a second direction perpendicular to the first direction, a distance exists between the outer end and the second side.

In one embodiment of the present disclosure, the movable portion includes a top surface facing the flexible display panel and a side wall connected to the top surface, and in a second direction perpendicular to the first direction, a distance exists between the first adhesive portion and the side wall.

In one embodiment of the present disclosure, the non-adhesive region includes a first portion, and the first portion is close to a periphery of the movable portion.

In one embodiment of the present disclosure, the non-adhesive region further includes a second portion, the second portion is located close to a center of the movable portion, and the second part is separated from the first portion.

In one embodiment of the present disclosure, the non-adhesive region is located between the first adhesive portion and the flexible display panel, or the non-adhesive region is located between the first adhesive portion and the lifting mechanism.

Based on the foregoing, in the display device of the present disclosure, the bonding layer is disposed between the lifting mechanism and the flexible display panel, the bonding layer includes the first adhesive portion and the non-adhesive region, the first adhesive portion at least corresponds to the fixed portion, and the non-adhesive region corresponds to at least a portion of the movable portion and to a portion of the fixed portion close to the movable portion, thus preventing strain concentration in specific regions in the switching process that would otherwise cause excessive strain.

These and other aspects of the present disclosure will become apparent from the following description of the embodiment taken in conjunction with the following drawings, detailed description and the claims.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1A is a cross-sectional schematic view of a display device according to one embodiment of the present disclosure.

FIG. 1B is a cross-sectional schematic view of the display device of FIG. 1A in another state.

FIG. 2A is a cross-sectional schematic view of a display device according to one embodiment of the present disclosure.

FIG. 2B is a cross-sectional schematic view of the display device of FIG. 2A in another state.

FIG. 3 is an exploded view of a display device according to one embodiment of the present disclosure.

FIG. 4A is a cross-sectional schematic view of a display device according to one embodiment of the present disclosure.

FIG. 4B is a cross-sectional schematic view of the display device of FIG. 4A in another state.

FIG. 5A is a cross-sectional schematic view of a display device according to one embodiment of the present disclosure.

FIG. 5B is a cross-sectional schematic view of the display device of FIG. 5A in another state.

FIG. 6A is a cross-sectional schematic view of a display device according to one embodiment of the present disclosure.

FIG. 6B is a cross-sectional schematic view of the display device of FIG. 6A in another state.

FIG. 6C is a cross-sectional schematic view of a display device according to one embodiment of the present disclosure.

FIG. 6D is a cross-sectional schematic view of the display device of FIG. 6C in another state.

FIG. 7A is a cross-sectional schematic view of a display device according to one embodiment of the present disclosure.

FIG. 7B is a cross-sectional schematic view of the display device of FIG. 7A in another state.

FIG. 8A is a cross-sectional schematic view of a display device according to one embodiment of the present disclosure.

FIG. 8B is a cross-sectional schematic view of the display device of FIG. 8A in another state.

### DETAILED DESCRIPTION

As used herein, the term “close to” refers to an element, a component, a region, a layer and/or a portion being physically located closer to a reference (which may also be an element, a component, a region, a layer and/or a portion) compared to other related components, regions, layers and/or portions. For example, “a portion P of a component A close to a reference component R” means that the portion P of the component A, compared to other portions of the component A, is located closer to the reference component R.

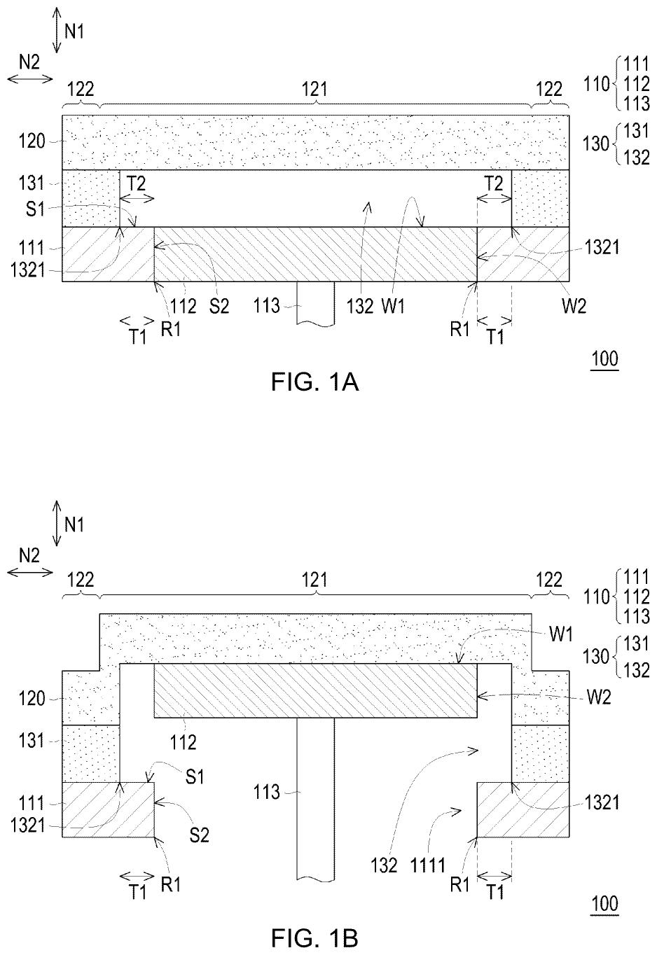

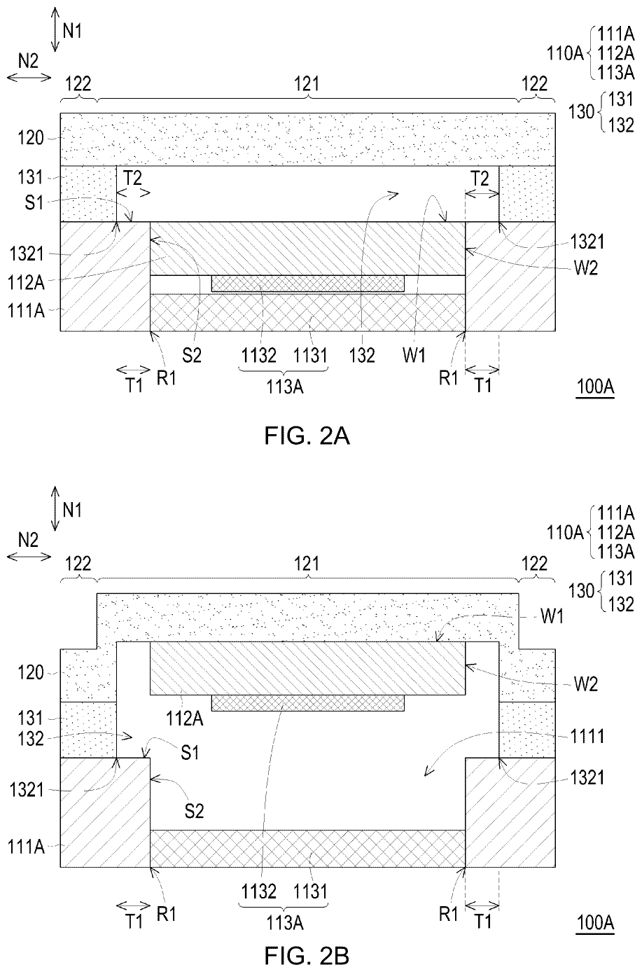

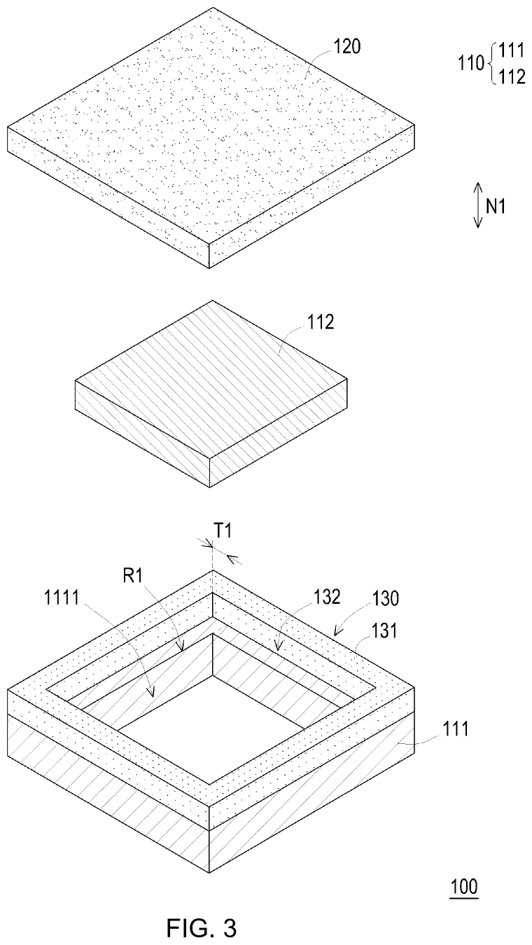

FIG. 1A is a cross-sectional schematic view of a display device according to one embodiment of the present disclosure. FIG. 1B is a cross-sectional schematic view of the display device of FIG. 1A in another state. FIG. 2A is a cross-sectional schematic view of a display device according to one embodiment of the present disclosure. FIG. 2B is a cross-sectional schematic view of the display device of FIG. 2A in another state. FIG. 3 is an exploded view of a display device according to one embodiment of the present disclosure.

Referring first to FIGS. 1A and 1B, the display device 100 of the present embodiment includes a lifting mechanism 110, a flexible display panel 120 and a bonding layer 130. The lifting mechanism 110 includes a fixed portion 111, a movable portion 112 and a driving portion 113. The fixed portion 111 includes a receiving space 1111, and the movable portion 112 is movably located in the receiving space 1111. That is, the fixed portion 111 is located outside the movable portion 112.

In the present embodiment, the flexible display panel 120 is disposed on the lifting mechanism 110 and has a first region 121 and a second region 122. The second region 122 surrounds the first region 121. That is, the second region 122 is located outside the first region 121.

In the present embodiment, the movable portion 112 is configured to lift relative to the fixed portion 111 to drive the first region 121 upward so as to protrude relative to the second region 122, but the present disclosure is not limited thereto.

In the present embodiment, the driving portion 113 is connected to the movable portion 112, and the movable portion 112 is movably disposed in the receiving space 1111 along a first direction N1. When the movable portion 112 is located in the receiving space 1111, the movable portion 112 does not contact the flexible display panel 120, and when the movable portion 112 moves upward to be out of the receiving space 1111, the movable portion 112 directly contacts the first region 121 of the flexible display panel 120. Here, the driving portion 113 is a lifting column, and the driving portion 113 may be driven by a power source (for example, a motor), such that the driving unit 113 moves up and down along the first direction N1, thereby driving the movable portion 112 to move up and down along the first direction N1, but is not limited thereto.

In another embodiment, referring to FIGS. 2A and 2B, the display device 100A includes a lifting mechanism 110A. The lifting mechanism 110A includes a fixed portion 111A, a movable portion 112A and a driving portion 113A. The driving portion 113A is a magnetic assembly, and the driving portion 113A includes a first magnetic member 1131 and a second magnetic member 1132. The driving portion 113A uses magnetic repulsion or magnetic attraction generated between the first magnetic member 1131 and the second magnetic member 1132 to move the movable portion 112A up and down, but is not limited thereto. In one embodiment, the first magnetic member 1131 is, for example, an electromagnet, and the second magnetic member 1132 is, for example, a permanent magnet. When current flows through the first magnetic member 1131, the first magnetic member 1131 acquires polarity. In addition, when no current flows through the first magnetic member 1131, the first magnetic member 1131 is demagnetized and has no polarity, but the present disclosure is not limited thereto.

In the present embodiment, by means of the flexible display panel 120, the display device 100 may be freely switched between planar and curved states. For example, when the flexible display panel 120 is used as a screen, the flexible display panel 120 remains flat. As shown in FIG. 1A, the flexible display panel 120 presents a uniform surface, which may prevent unintended touch input errors. When a user needs to operate keys, the flexible display panel 120 may be made to protrude partially (for example, in the first region 121) through the lifting mechanism 110 to form a physical key. As shown in FIG. 1B, the flexible display panel 120 presents a non-uniform surface. Thus, the user may type quickly and accurately with feedback, as when operating a physical keyboard. It should be noted that FIGS. 1A and 1B merely schematically show a single-region protrusion, for example, a state showing a single protruding key. However, in other embodiments, the first region 121 may be arranged in multiple distributions to form multiple protrusions, and the present disclosure is not limited thereto.

In detail, in the present embodiment, the bonding layer 130 is disposed between the lifting mechanism 110 and the flexible display panel 120, and the bonding layer 130 includes a first adhesive portion 131 and a non-adhesive region 132. Here, the first adhesive portion 131 is a gel, and the non-adhesive region 132 is an air gap, but the present disclosure is not limited thereto. In the present embodiment, the first adhesive portion 131 at least corresponds to the fixed portion 111, and the non-adhesive region 132 corresponds to at least a portion of the movable portion 112 and to a portion of the fixed portion 111 close to the movable portion 112.

In the present embodiment, in the first direction N1, the non-adhesive region 132 at least overlaps with a junction R1 between the movable portion 112 and the fixed portion 111. Further, the fixed portion 111 includes a first side S1 and a second side S2 adjacent to each other. The first side S1 faces the flexible display panel 120, and the second side S2 faces the receiving space 1111. The non-adhesive region 132 has an outer end 1321 close to the first adhesive portion 131, and the outer end 1321 overlaps with the fixed portion 111 in the first direction N1. In a second direction N2 perpendicular to the first direction N1, a distance T1 exists between the outer end 1321 and the second side S2, and the distance T1 is greater than 2 micrometers (μm), but the present disclosure is not limited thereto. In addition, the movable portion 112 includes a top surface W1 facing the flexible display panel 120 and a side wall W2 connected to the top surface W1. In the second direction N2, a distance T2 exists between the first adhesive portion 131 and the sidewall W2, and the distance T2 is greater than 2 micrometers (μm), but the present disclosure is not limited thereto.

In the present embodiment, the non-adhesive region 132 completely overlaps with the top surface W1 and extends to a portion of the first side S1. Thus, at the lift ramp, the flexible display panel 120 is not adhesively fixed to the movable portion 112 (i.e., adhesive is not applied in a portion of the region). Here, the entire lift top surface W1 is non-adhesive, but the present disclosure is not limited thereto. In one embodiment, an area ratio of the top surface W1 of the movable portion 112 being adhered to the flexible display panel 120 is ≤90%, but the present disclosure is not limited thereto.

In the present embodiment, an extending direction of the side wall W2 is parallel to the first direction N1, that is, the side wall W2 is perpendicular to the top surface W1, and a cross-section of the movable portion 112 is square. However, in other embodiments, the side wall W2 may be inclined with respect to the first direction N1, that is, the side wall W2 may be inclined relative to the top surface W1 so that the cross-section of the movable portion 112 is trapezoidal, and the present disclosure is not limited thereto.

Referring to FIGS. 1A and 3, in the present embodiment, the non-adhesive region 132 completely covers the movable portion 112 and covers the region above the junction R1 between the movable portion 112 and the fixed portion 111, but the present disclosure is not limited thereto. In other embodiments, the non-adhesive region 132 may be provided only at multiple corner portions of the junction R1 between the movable portion 112 and the fixed portion 111. That is, the region above the movable portion 112 is not entirely an air gap, and air gaps are provided only at multiple corner portions of the junction R1, and the present disclosure is not limited thereto.

Under the above configuration, the non-adhesive region 132 allows sliding between the movable portion 112 and the flexible display panel 120, which may present strain concentration in specific regions that would otherwise cause excessive strain when the flexible display panel 120 changes from the planar state to the curved state.

Other embodiments will be listed below for descriptions. It should be noted that the following embodiments continue the reference numerals of components and portions of the content of the foregoing embodiments, in which identical reference numerals refer to denote identical or similar components, and the descriptions of identical technical contents are omitted. Descriptions of the omitted contents may refer to the foregoing embodiments, and are thus not further elaborated in the following embodiments.

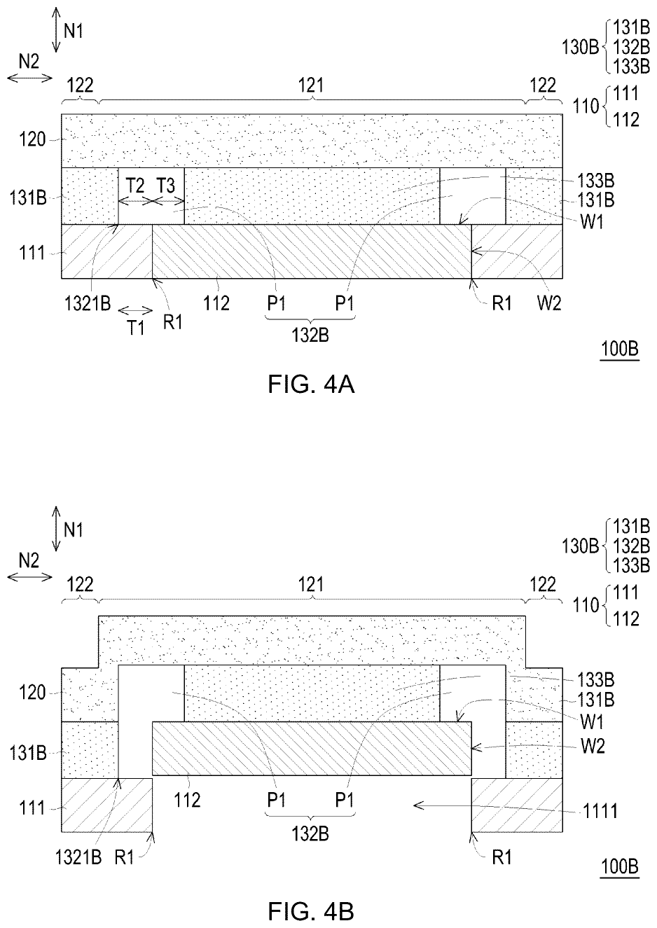

FIG. 4A is a cross-sectional schematic view of a display device according to one embodiment of the present disclosure. FIG. 4B is a cross-sectional schematic view of the display device of FIG. 4A in another state. It should be noted that the driving portion is not illustrated in FIGS. 4A and 4B, and the configuration and operation of the driving portion may refer to the implementation description for FIGS. 1A and 1B, but are not limited thereto.

Referring to FIGS. 4A and 4B, the bonding layer 130B of the display device 100B of the present embodiment includes a first adhesive portion 131B, a second adhesive portion 133B and a non-adhesive region 132B. Here, the non-adhesive region 132B is an air gap, but the present disclosure is not limited thereto.

In the present embodiment, the non-adhesive region 132B includes a first portion P1. The first portion P1 is close to the side wall W2 at the periphery of the movable portion 112, and the first portion P1 is located outside the second adhesive portion 133B. A distance T3 exists between the second adhesive portion 133B and the sidewall W2, and the distance T3 is greater than 2 micrometers (μm), but the present disclosure is not limited thereto.

In the present embodiment, an outer end 1321B of the non-adhesive region 132B closest to the second region 122 overlaps with the fixed portion 111 in the first direction N1. In the second direction N2, a distance T1 exists between the outer end 1321B of the non-adhesive region 132B and the second side S2. In addition, in the second direction N2, a distance T2 exists between the first adhesive portion 131B and the side wall W2. Thus, at the lift ramp, the flexible display panel 120 is not adhesively fixed to the movable portion 112 (i.e., adhesive is not applied in a portion of the region). Here, a second adhesive portion 133B is provided above the lift top surface W1, such that the top surface W1 is partially not adhered to the flexible display panel 120, but the present disclosure is not limited thereto. In one embodiment, an area ratio of the top surface W1 of the movable portion 112 being adhered to the flexible display panel 120 is ≤90%, but the present disclosure is not limited thereto. In this way, the non-adhesive region 132B allows sliding between the movable portion 112 and the flexible display panel 120, which may prevent strain concentration in specific regions that would otherwise cause excessive strain when the flexible display panel 120 changes from a planar state to a curved state.

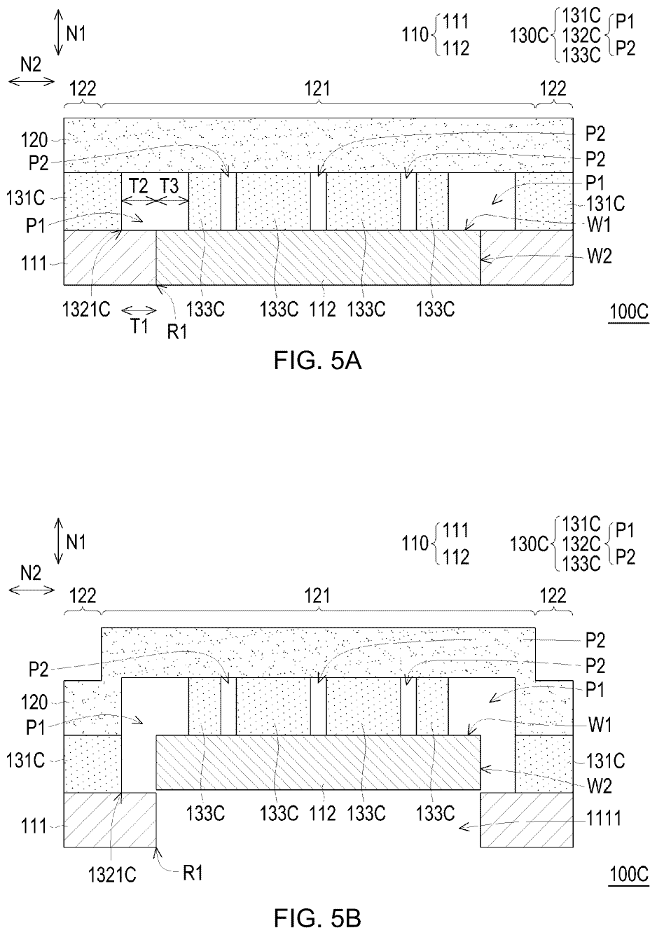

FIG. 5A is a cross-sectional schematic view of a display device according to one embodiment of the present disclosure. FIG. 5B is a cross-sectional schematic view of the display device of FIG. 5A in another state. It should be noted that the driving portion is not illustrated in FIGS. 5A and 5B, and the configuration and operation of the driving portion may refer to the implementation description for FIGS. 1A and 1B, but are not limited thereto.

Referring to FIGS. 5A and 5B, the bonding layer 130C of the display device 100C of the present embodiment includes a first adhesive portion 131C, a second adhesive portion 133C and a non-adhesive region 132C. Here, the non-adhesive region 132C is an air gap, but the present disclosure is not limited thereto. For example, the second adhesive portion 133C is separated by multiple air gaps and is arranged in segments, but the present disclosure is not limited thereto.

In the present embodiment, the non-adhesive region 132C includes a first portion P1 and a second portion P2. The first portion P1 is located outside the second adhesive portion 133C and is close to the side wall W2 at the periphery of the movable portion 112. A distance T3 exists between the second adhesive portion 133C close to the second region 122 and the side wall W2. The second portion P2 is close to a center of the movable portion 112, and the second portion P2 is separated from the first part P1.

In the present embodiment, an outer end 1321C of the non-adhesive region 132C closest to the second region 122 overlaps with the fixed portion 111 in the first direction N1. In the second direction N2, a distance T1 exists between the outer end 1321C of the non-adhesive region 132C and the second side S2. In addition, in the second direction N2, a distance T2 exists between the first adhesive portion 131C and the side wall W2. Thus, at the lift ramp, the flexible display panel 120 is not adhesively fixed to the movable portion 112 (i.e., adhesive is not applied in a portion of the region). Here, the lift top surface W1 is partially non-adhesive, but the present disclosure is not limited thereto. In one embodiment, an area ratio of the top surface W1 of the movable portion 112 being adhered to the flexible display panel 120 is ≤90%, but the present disclosure is not limited thereto. In this way, the non-adhesive region 132C allows sliding between the movable portion 112 and the flexible display panel 120, which may prevent strain concentration in specific regions that would otherwise cause excessive strain when the flexible display panel 120 changes from a planar state to a curved state.

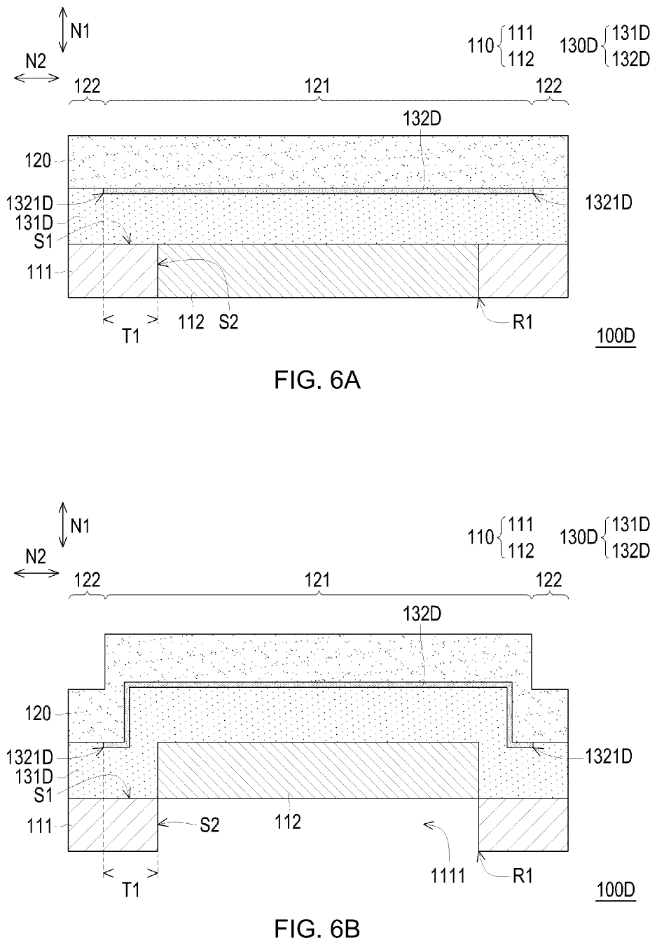

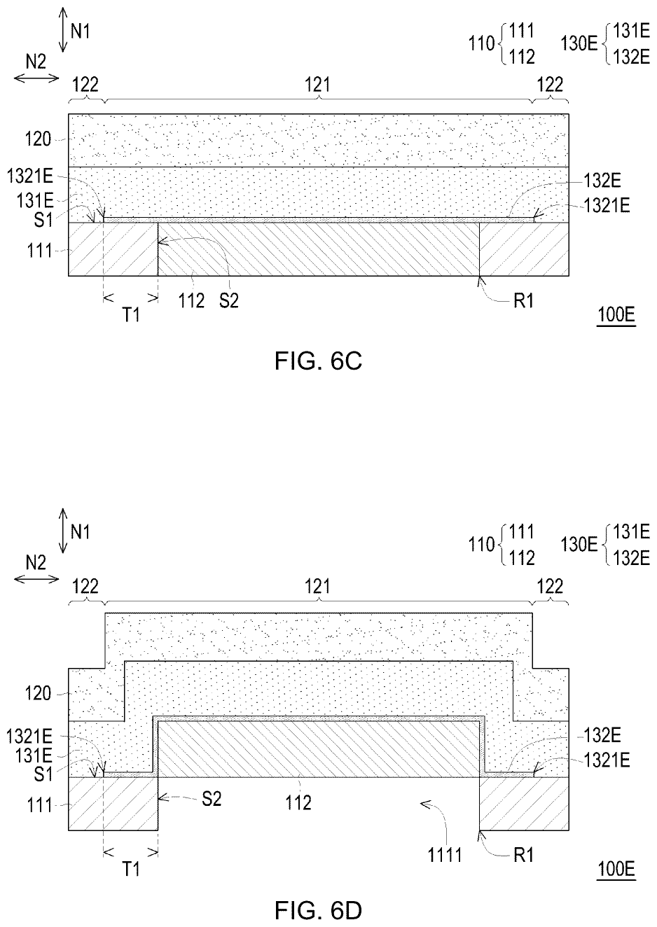

FIG. 6A is a cross-sectional schematic view of a display device according to one embodiment of the present disclosure. FIG. 6B is a cross-sectional schematic view of the display device of FIG. 6A in another state. FIG. 6C is a cross-sectional schematic view of a display device according to one embodiment of the present disclosure. FIG. 6D is a cross-sectional schematic view of the display device of FIG. 6C in another state. It should be noted that the driving portion is not illustrated in FIGS. 6A to 6D, and the configuration and operation of the driving portion may refer to the implementation description for FIGS. 1A and 1B, but are not limited thereto.

Referring to FIGS. 6A and 6B, the bonding layer 130D of the display device 100D of the present embodiment includes a first adhesive portion 131D and a non-adhesive region 132D, and the non-adhesive region 132D is located between the first adhesive portion 131D and the first region 121. Here, a partial upper surface of the first adhesive portion 131D, after being performed with surface treatment, forms the non-adhesive region 132D, and the surface treatment may be, for example, ashing, which renders the adhesive non-adhesive, but the present disclosure is not limited thereto.

In the present embodiment, the non-adhesive region 132D is located between the first adhesive portion 131D and the flexible display panel 120, but the present disclosure is not limited thereto. Referring to FIGS. 6C and 6D, the non-adhesive region 132E is located between the first adhesive portion 131E and the lifting mechanism 110. An outer end 1321E of the non-adhesive region 132E closest to the second region 122 overlaps with the fixed portion 111 in the first direction N1. Here, a partial lower surface of the first adhesive portion 131E, after being performed with surface treatment, forms the non-adhesive region 132E, and the surface treatment may be, for example, ashing, but the present disclosure is not limited thereto.

Further referring to FIGS. 6A and 6B, the outer end 1321D of the non-adhesive region 132D closest to the second region 122 overlaps with the fixed portion 111 in the first direction N1. In the second direction N2, a distance T1 exists between the outer end 1321D of the non-adhesive region 132D and the second side S2. Thus, at the lift ramp, the flexible display panel 120 is not adhesively fixed to the movable portion 112 (i.e., a portion of the region is non-adhesive). In one embodiment, an area ratio of the top surface W1 of the movable portion 112 being adhered to the flexible display panel 120 is ≤90%, but the present disclosure is not limited thereto. In this way, the non-adhesive region 132D allows sliding between the movable portion 112 and the flexible display panel 120, which may prevent strain concentration in specific regions that would otherwise cause excessive strain when the flexible display panel 120 changes from a planar state to a curved state.

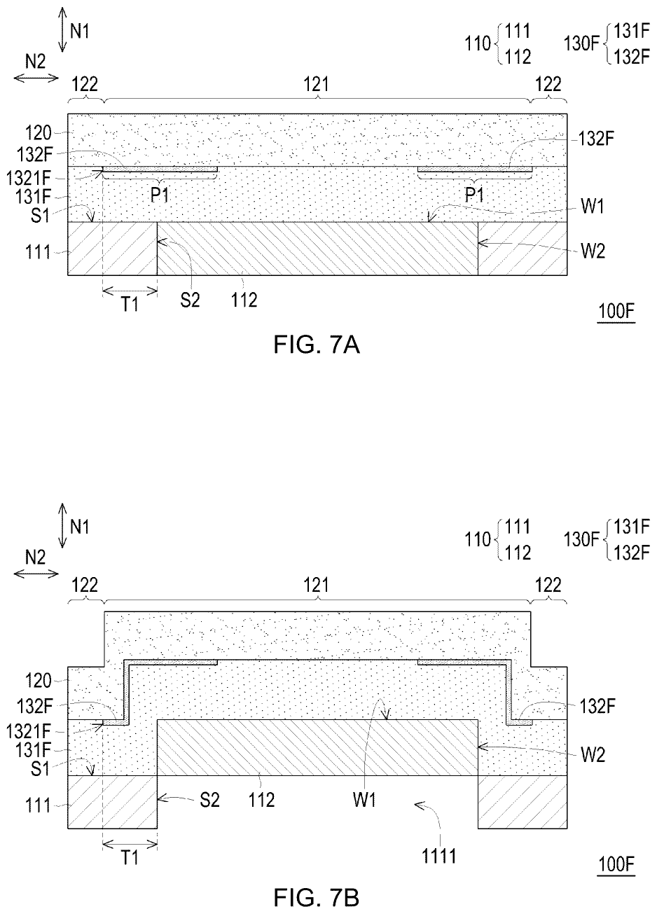

FIG. 7A is a cross-sectional schematic view of a display device according to one embodiment of the present disclosure. FIG. 7B is a cross-sectional schematic view of the display device of FIG. 7A in another state. It should be noted that the driving portion is not illustrated in FIGS. 7A and 7B, and the configuration and operation of the driving portion may refer to the implementation description for FIGS. 1A and 1B, but are not limited thereto.

Referring to FIGS. 7A and 7B, the bonding layer 130F of the display device 100F of the present embodiment includes a first adhesive portion 131F and a non-adhesive region 132F. The non-adhesive region 132F includes a first portion P1, and the first portion P1 is close to the side wall W2 at the periphery of the movable portion 112.

In the present embodiment, an outer end 1321F of the non-adhesive region 132F closest to the second region 122 overlaps with the fixed portion 111 in the first direction N1. In the second direction N2, a distance T1 exists between the outer end 1321F of the non-adhesive region 132F and the second side S2. Thus, at the lift ramp, the flexible display panel 120 is not adhesively fixed to the movable portion 112 (i.e., a portion of the region is non-adhesive). In one embodiment, an area ratio of the top surface W1 of the movable portion 112 being adhered to the flexible display panel 120 is ≤90%, but the present disclosure is not limited thereto. In this way, the non-adhesive region 132F allows sliding between the movable portion 112 and the flexible display panel 120, which may prevent strain concentration in specific regions that would otherwise cause excessive strain when the flexible display panel 120 changes from a planar state to a curved state.

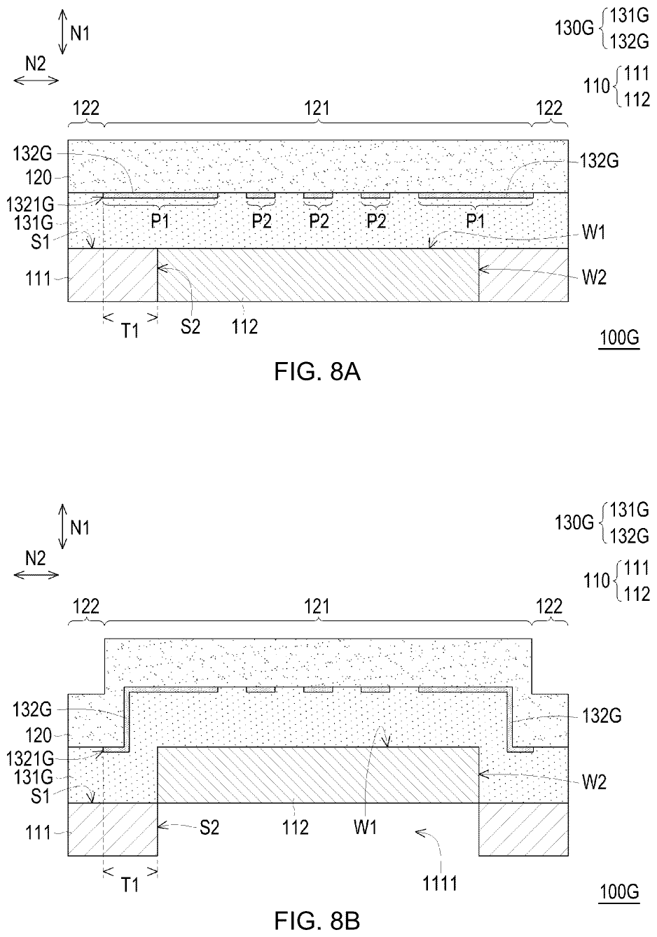

FIG. 8A is a cross-sectional schematic view of a display device according to one embodiment of the present disclosure. FIG. 8B is a cross-sectional schematic view of the display device of FIG. 8A in another state. It should be noted that the driving portion is not illustrated in FIGS. 8A and 8B, and the configuration and operation of the driving portion may refer to the implementation description for FIGS. 1A and 1B, but are not limited thereto.

Referring to FIGS. 8A and 8B, the bonding layer 130G of the display device 100G of the present embodiment includes a first adhesive portion 131G and a non-adhesive region 132G. The non-adhesive region 132G includes a first portion Pl and a second portion P2. The first part P1 is close to the side wall W2 at the periphery of the movable portion 112. The second portion P2 is close to a center of the movable portion 112, and the second portion P2 is separate from the first portion P1. The second portion P2 is disposed in segments on an upper surface of the first adhesive portion 131G that faces the flexible display panel 120, but the present disclosure is not limited thereto.

In the present embodiment, an outer end 1321G of the non-adhesive region 132G close to the second region 122 overlaps with the fixed portion 111 in the first direction N1. In the second direction N2, a distance T1 exists between the outer end 1321G of the non-adhesive region 132GD and the second side S2. Thus, at the lift ramp, the flexible display panel 120 is not adhesively fixed to the movable portion 112 (i.e., a portion of the region is non-adhesive). In one embodiment, an area ratio of the top surface W1 of the movable portion 112 being adhered to the flexible display panel 120 is ≤90%, but the present disclosure is not limited thereto. In this way, the non-adhesive region 132G allows sliding between the movable portion 112 and the flexible display panel 120, which may prevent strain concentration in specific regions that would otherwise cause excessive strain when the flexible display panel 120 changes from a planar state to a curved state.

In sum, in the display device according to certain embodiments of the present disclosure, the flexible display panel is disposed on the lifting mechanism, and the lifting mechanism includes a movable portion and a fixed portion. By pushing the flexible display panel using the movable portion, the display device may be freely switched between planar and curved states. The bonding layer is disposed between the lifting mechanism and the flexible display panel, and the bonding layer includes a first adhesive portion and a non-adhesive region. The non-adhesive region at least overlaps with the junction between the movable portion and the fixed portion. Thus, the flexible display panel is not completely fixed to the movable portion. In this way, the non-adhesive region allows sliding between the movable portion and the flexible display panel, which may prevent strain concentration in specific regions that would otherwise cause excessive strain when the flexible display panel changes from a planar state to a curved state.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A display device, comprising:
a lifting mechanism, comprising a fixed portion and a movable portion, wherein the fixed portion is located outside the movable portion;
a flexible display panel, disposed on the lifting mechanism and having a first region and a second region, wherein the second region is located outside the first region, and wherein the movable portion is configured to lift relative to the fixed portion to drive the first region upward so as to protrude relative to the second region; and
a bonding layer, disposed between the lifting mechanism and the flexible display panel, wherein the bonding layer comprises a first adhesive portion and a non-adhesive region, the first adhesive portion at least corresponds to the fixed portion, and the non-adhesive region corresponds to at least a portion of the movable portion and to a portion of the fixed portion close to the movable portion.

2. The display device of claim 1, wherein the fixed portion comprises a receiving space, and the movable portion is movably disposed in the receiving space along a first direction.

3. The display device of claim 2, wherein the lifting mechanism further comprises a driving portion connected to the movable portion.

4. The display device of claim 2, wherein in the first direction, the non-adhesive region at least overlaps with a junction between the movable portion and the fixed portion.

5. The display device of claim 2, wherein the fixed portion comprises a first side and a second side adjacent to each other, the first side faces the flexible display panel, the second side faces the receiving space, the non-adhesive region has an outer end close to the first adhesive portion, and the outer end overlaps with the fixed portion in the first direction.

6. The display device of claim 5, wherein in a second direction perpendicular to the first direction, a distance exists between the outer end and the second side.

7. The display device of claim 2, wherein the movable portion comprises a top surface facing the flexible display panel and a side wall connected to the top surface, and in a second direction perpendicular to the first direction, a distance exists between the first adhesive portion and the side wall.

8. The display device of claim 1, wherein the non-adhesive region comprises a first portion, and the first portion is close to a periphery of the movable portion.

9. The display device of claim 8, wherein the non-adhesive region further comprises a second portion, the second portion is located close to a center of the movable portion, and the second part is separated from the first portion.

10. The display device of claim 1, wherein the non-adhesive region is located between the first adhesive portion and the flexible display panel, or the non-adhesive region is located between the first adhesive portion and the lifting mechanism.
